(19) United States
(12) Patent Application Publication
(10) Pub. No.: US 2025/0242764 A1
(43) Pub. Date: Jul. 31, 2025

(54) CLIPS FOR ASSEMBLY

(71) Applicant: Rivian IP Holdings, LLC, Irvine, CA (US)

(72) Inventor: Mustafa SONCAG, Inkster, MI (US)

(21) Appl. No.: 18/426,193

(22) Filed: Jan. 29, 2024

(51) Int. Cl. B60R 13/02; F16B 2/22

(52) U.S. Cl. CPC B60R 13/0206; F16B 2/22

(57) ABSTRACT

Aspects of the disclosure relate to clips to facilitate securement of an assembly that maintains an alignment of the components thereof. A clip can ensure that a consistent gap and/or flushness between two components are achieved without needing to hard tool another securement mechanism, such as a bracket. The clip can either grip onto an outer surface of the components (e.g., with teeth) or snap into openings in the components (e.g., with latches). The clip can optionally have asymmetric features to couple components of different materials (e.g., metal and plastic) to each other. An assembly incorporating such a clip can have a lower cost per part, a reduced weight, a fewer number of parts, and provide greater ease of assembly.

### INTRODUCTION

Vehicles often include assembled parts that are designed to be aligned in a particular way. For example, surfaces and/or edges of separate parts can be aligned with an intended gap and/or to be flush with each other. Such an alignment can extend across opposing surfaces and/or edges of the separate parts.

Aspects of the subject technology can help to improve securement and alignment of assembled parts by providing reversible securement with a clip.

### SUMMARY

The present description relates generally to clips for securing two adjacent components (e.g., of a vehicle) together. The clip ensures that a consistent gap and/or flushness between two components are achieved without needing to hard tool another securement mechanism, such as a bracket. The clip can either grip onto an outer surface of the components (e.g., with teeth) or snap into openings in the components (e.g., with latches). The clip can optionally have asymmetric features to couple components of different materials (e.g., metal and plastic) to each other.

In accordance with one or more aspects of the disclosure, a clip can include a rear wall, a first outer arm extending from the rear wall, a second outer arm extending from the rear wall, and an inner arm extending from a portion of the rear wall that is between the first outer arm and the second outer arm. The clip can further include a first tooth extending from the first outer arm toward the rear wall and a second tooth extending from the inner arm toward the rear wall, the first tooth and the second tooth being biased toward each other. The clip can further include a latch extending from the second outer arm toward the rear wall, the latch being biased toward the inner arm.

A gap between the second outer arm and the inner arm can be larger than a gap between the first outer arm and the inner arm. An end portion of the first outer arm and an end portion of the inner arm flare away from each other. A tab of the latch extends away from the inner arm. The first tooth and the second tooth are biased towards each other. The clip can also include a third tooth extending from the first outer arm and in parallel with the first tooth and a fourth tooth extending from the inner arm and in parallel with the second tooth.

In accordance with one or more aspects of the disclosure, a clip can include a rear wall, a first outer arm extending from the rear wall, a second outer arm extending from the rear wall, and an inner arm extending from a portion of the rear wall that is between the first outer arm and the second outer arm. The clip can also include a first latch extending from the first outer arm toward the rear wall, the first latch being biased toward the inner arm and a second latch extending from the second outer arm toward the rear wall, the second latch being biased toward the inner arm.

The clip can be symmetric on opposing sides of the inner arm. The first latch has a first height that can be different than a second height of the second latch. The clip can also include a tooth extending from the first outer arm toward the rear wall and being biased toward the inner arm. A gap between the second outer arm and the inner arm can be larger than a gap between the first outer arm and the inner arm. An end portion of the first outer arm and an end portion of the inner arm flare away from each other. A first tab forming an end of the first latch extends away from the inner arm and a second tab forming an end of the second latch extends away from the inner arm.

In accordance with one or more aspects of the disclosure, a vehicle can include a first component having a first opening and a second component having a second opening and forming a recess. The vehicle can include a clip with a first outer arm extending on an outer side of the first component, a second outer arm extending on an outer side of the second component, and an inner arm extending between the first component and the second component and within the recess of the second component. The clip can also include a first latch extending from the first outer arm and into the first opening of the first component and a second latch extending from the second outer arm and into the second opening of the second component.

The clip can be symmetric on opposing sides of the inner arm, wherein a second thickness of the second component can be equal to a first thickness of the first component. The second latch has a height that can be less than a height of the second opening of the second component, wherein the second component can be slidable with respect to the clip while the second latch is within the second opening. The vehicle can also include a tooth extending from the first outer arm and being biased against the first component. A second thickness of the second component can be greater than a first thickness of the first component, and a gap between the second outer arm and the inner arm can be larger than a gap between the first outer arm and the inner arm. An end portion of the first outer arm and an end portion of the inner arm flare away from each other. A first tab forming an end of the first latch extends away from the inner arm, and a second tab forming an end of the second latch extends away from the inner arm.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a schematic perspective side views of example implementations of a vehicle in accordance with one or more implementations.

FIG. 2 illustrates a schematic front perspective view of an example implementation of a vehicle in accordance with one or more implementations.

FIG. 3 illustrates a perspective view of a clip, in accordance with implementations of the subject technology.

FIG. 4 illustrates a side view of the clip of FIG. 3, in accordance with implementations of the subject technology.

FIG. 5 illustrates a top sectional view the clip of FIGS. 3 and 4 taken along line A-A of FIG. 4, in accordance with implementations of the subject technology.

FIG. 6 illustrates a perspective view of an assembly in a first stage with the clip of FIGS. 3-5, in accordance with implementations of the subject technology.

FIG. 7 illustrates a perspective view of the assembly of FIG. 6 in a second stage with the clip of FIGS. 3-5, in accordance with implementations of the subject technology.

FIG. 8 illustrates a perspective view of the assembly of FIGS. 6 and 7 in a third stage with the clip of FIGS. 3-5, in accordance with implementations of the subject technology.

FIG. 9 illustrates another perspective sectional view of the assembly of FIGS. 6-8 in the third stage with the clip of FIGS. 3-5, in accordance with implementations of the subject technology.

FIG. 10 illustrates a perspective view of a clip, in accordance with implementations of the subject technology.

FIG. 11 illustrates a side view of the clip of FIG. 10, in accordance with implementations of the subject technology.

FIG. 12 illustrates a top sectional view the clip of FIGS. 10 and 11 taken along line B-B of FIG. 11, in accordance with implementations of the subject technology.

FIG. 13 illustrates a perspective view of an assembly in a first stage with the clip of FIGS. 10-12, in accordance with implementations of the subject technology.

FIG. 14 illustrates a perspective view of the assembly of FIG. 13 in a second stage with the clip of FIGS. 10-12, in accordance with implementations of the subject technology.

FIG. 15 illustrates a perspective view of the assembly of FIGS. 13 and 14 in a third stage with the clip of FIGS. 10-12, in accordance with implementations of the subject technology.

FIG. 16 illustrates another perspective sectional view of the assembly of FIGS. 13-15 in the third stage with the clip of FIGS. 10-12, in accordance with implementations of the subject technology.

FIG. 17 illustrates a perspective view of a clip, in accordance with implementations of the subject technology.

FIG. 18 illustrates a perspective view of a clip, in accordance with implementations of the subject technology.

FIG. 19 illustrates a perspective view of a clip, in accordance with implementations of the subject technology.

FIG. 20 illustrates a side view of the clip of FIG. 19, in accordance with implementations of the subject technology.

FIG. 21 illustrates a perspective view of a removal tool, in accordance with implementations of the subject technology.

FIG. 22 illustrates a perspective view of a removal tool partially engaged with a clip of an assembly, in accordance with implementations of the subject technology.

FIG. 23 illustrates a perspective view of the removal tool and the clip partially removed from the assembly of FIG. 22, in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In many vehicles, parts are assembled with an intended gap and/or alignment (e.g., abutment) between the assembled parts. For example, exterior parts can be provided in an alignment that presents parallel edges and/or flush surfaces. Such an alignment can extend across opposing surfaces and/or edges of the separate parts. Some solutions can include hard tooling a bracket or other securement mechanism to provide robust support for the parts to be joined together. However, such a solution can be costly and may be unable to be reused after disassembly. Such a solution may further require additional parts (e.g., fasteners) to couple the bracket to the assembled parts.

Implementations of the subject technology described herein provide clips to facilitate securement of an assembly that maintains an alignment of the components thereof. As described herein, such a clip can ensure that a consistent gap and/or flushness between two components are achieved without needing to hard tool another securement mechanism, such as a bracket. The clip can either grip onto an outer surface of the components (e.g., with teeth) or snap into openings in the components (e.g., with latches). The clip can optionally have asymmetric features to couple components of different materials (e.g., metal and plastic) to each other. An assembly incorporating such a clip can have a lower cost per part, a reduced weight, a fewer number of parts, and provide greater ease of assembly.

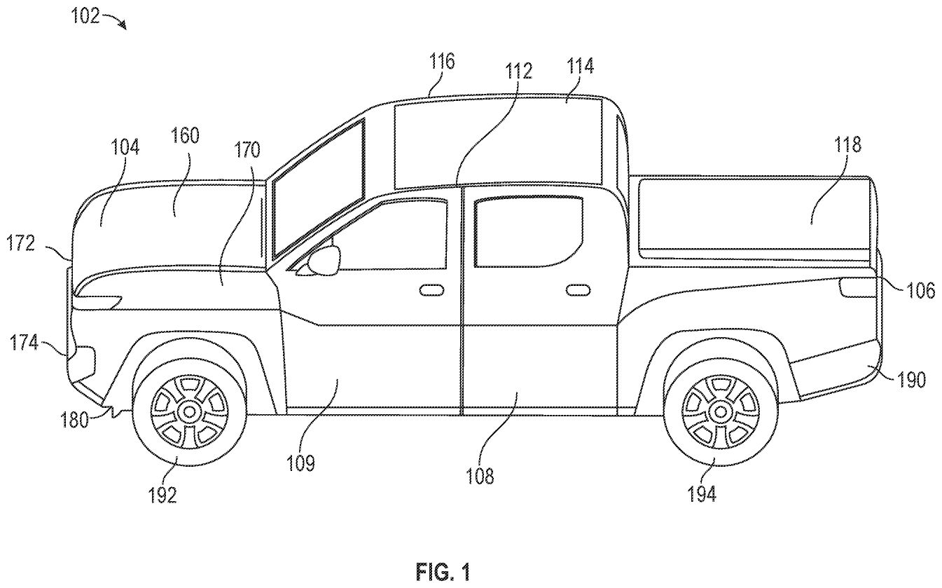

FIG. 1 is a diagram illustrating an example implementation of an apparatus as described herein. In the example of FIG. 1, an apparatus is implemented as a moveable apparatus, such as a vehicle 102. As shown, the vehicle 102 may have a front portion 104 and a rear portion 106. A cabin 108 may be located between the front portion 104 and the rear portion 106 of the vehicle 102. The cabin 108 may include entry doors 109. As illustrated, the vehicle 102 has a left side 112 and a right side 116.

The vehicle 102 may include a roof 114. The vehicle 102 may have one or more cargo spaces, such as a cargo bed or truck bed 118 (also referred to herein as a “trunk”) and/or a hood 160 (e.g., covering a cargo area, front trunk, or a “frunk”). Cargo bed 118 is typically located at or near the rear portion 106 of the vehicle. The vehicle 102 may have one or more front wheels 192 and one or more rear wheels 194. The vehicle 102 of FIG. 1 may be a unibody truck, which may have a storage bed. One or more portions of a body 180 of the vehicle 102 may be constructed of steel alloy and/or aluminum alloy or other suitable materials.

As shown in the example of FIG. 1, the vehicle 102 may include one or more front fascia, such as a side front fascia 170, an upper front fascia 172, and/or a lower front fascia 174. As shown, the side front fascia 170 is located at the front end of the vehicle 102. Each of the side front fascia 170, the upper front fascia 172, and/or the lower front fascia 174 may provide an aesthetic front look for the vehicle 102 and may be arranged to provide external aerodynamic properties for the vehicle 102. By further example, one or more of the side front fascia 170, the upper front fascia 172, and/or the lower front fascia 174 can serve as a fender or bumper. In one or more implementations, each of the side front fascia 170, the upper front fascia 172, and/or the lower front fascia 174 may be implemented as removable sections of the front portion 104 of the vehicle 102 and may be comprised of plastic or non-metal components (carbon fiber) that hide one or more structural elements (e.g., bodywork/frame) and give the vehicle a desired outer shape. Each of the side front fascia 170, the upper front fascia 172, and/or the lower front fascia 174 can be adjustably coupled to the body 180 of the vehicle 102, as further described herein.

As further shown in the example of FIG. 1, the vehicle 102 may include one or more rear fascia, such as a rear fascia 190. As shown, the rear fascia 190 is located at the rear portion 106 of the vehicle 102. The rear fascia 190 may provide an aesthetic rear look for the vehicle 102 and may be arranged to provide external aerodynamic properties for the vehicle 102. By further example, the rear fascia 190 can serve as a fender or bumper. In one or more implementations, the rear fascia 190 may be implemented as removable sections of the rear portion 106 of the vehicle 102 and may be comprised of plastic or non-metal components (carbon fiber) that hide one or more structural elements (e.g., bodywork/frame) and give the vehicle a desired outer shape. The rear fascia 190 can be adjustably coupled to the body 180 of the vehicle 102, as further described herein.

While examples illustrated herein show clips and assemblies for coupling certain components (e.g., front fascia or rear fascia and the body, etc.) of a vehicle, it will be understood that the clips and/or assemblies described herein can be applied to any two or more components of the vehicle. Furthermore, it will be understood that the clips and/or assemblies described herein can be applied to any one of a variety of technologies, including any assembly of parts.

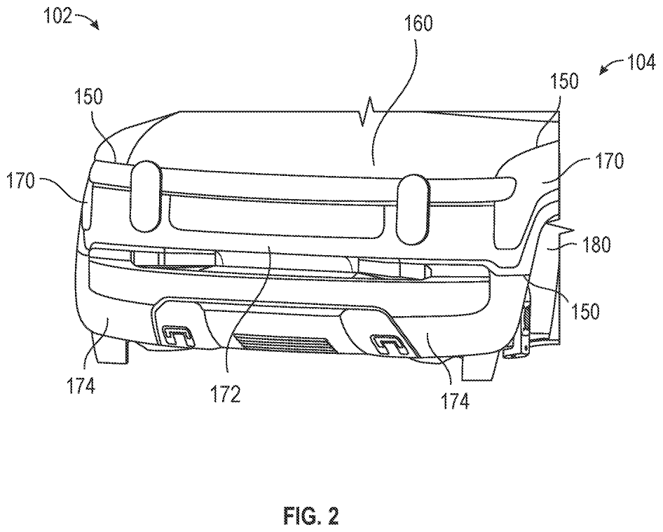

Referring now to FIG. 2, a portion (e.g., front portion) of the vehicle can include an assembly of parts. FIG. 2 illustrates a front perspective view of the front portion 104 of the vehicle 102 in accordance with one or more implementations. As shown in FIG. 2, the vehicle 102 may include the body 180 with each of the side front fascia 170, the upper front fascia 172, and/or the lower front fascia 174 being securely coupled to the body 180 and/or another structure. As shown in FIG. 2, an interface region 150 can be formed between any two components of the vehicle 102. Such an interface region 150 can be defined by the joining of any two components. For example, an interface region 150 can be formed between each of the hood 160 and the side front fascia 170, the hood 160 and the upper front fascia 172, the upper front fascia 172 and the lower front fascia 174, and/or any other two components.

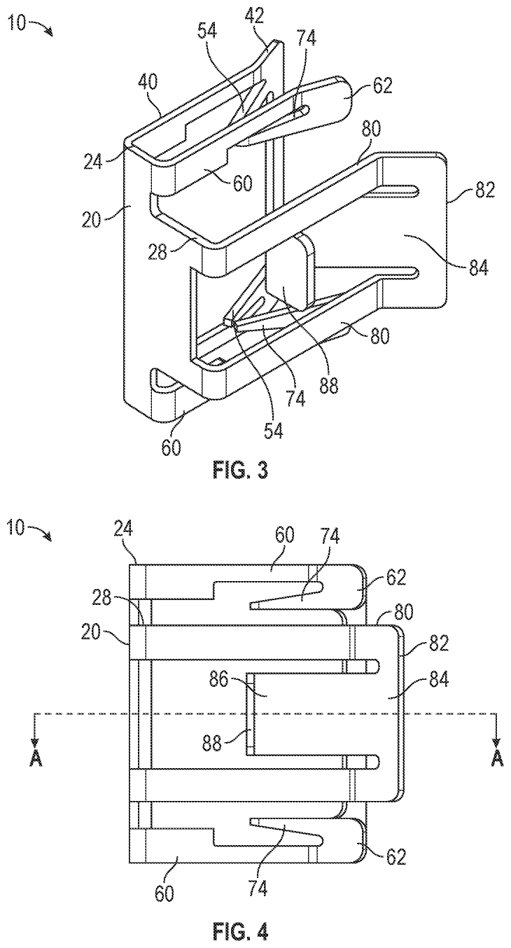

Referring now to FIGS. 3-5, a clip can be provided to secure two components to each other. Such a clip can provide various features for receiving and engaging the components in a secured configuration.

As shown in FIG. 3, a clip 10 can include a rear wall 20 on a side thereof. The rear wall 20 can define an end portion of the clip 10 against wish components received therein can abut. The clip 10 can further include multiple arms extending from the rear wall 20. For example, the clip 10 can include a first outer arm 40, a second outer arm 80, and an inner arm 60. Each of the first outer arm 40, the inner arm 60, and the second outer arm 80 can extend from the rear wall 20. At least a portion of each of the first outer arm 40, the inner arm 60, and the second outer arm 80 can extend in a same direction on a same side of the rear wall 20. For example, at least a portion of each of the first outer arm 40, the inner arm 60, and the second outer arm 80 can extend in parallel with each other. The inner arm 60 can extend from an inner portion of the rear wall 20 that is between outer portions of the rear wall 20, from which the first outer arm 40 and the second outer arm 80 extend. As such, the inner arm 60 can be between the first outer arm 40 and the second outer arm 80, with respect to a width across the rear wall 20.

As used herein, a length of the clip 10 and/or components thereof (e.g., the first outer arm 40, the inner arm 60, and/or the second outer arm 80) refers to a dimension extending away from and transverse (e.g., orthogonal) to the rear wall 20. As used herein, a height of the clip 10 and/or components thereof (e.g., the first outer arm 40, the inner arm 60, and/or the second outer arm 80) refers to a dimension extending through and/or parallel to the rear wall 20 and extending through and/or parallel to one of the first outer arm 40, the inner arm 60, and/or the second outer arm 80. As used herein, a width of the clip 10 and/or components thereof (e.g., the first outer arm 40, the inner arm 60, and/or the second outer arm 80) refers to a dimension extending through and/or parallel to the rear wall 20 and extending through and/or transverse to more than one of the first outer arm 40, the inner arm 60, and/or the second outer arm 80.

The rear wall 20 can define a first portion 24 that is between the first outer arm 40 and the inner arm 60. As such, the first portion 24 can join together the first outer arm 40 and the inner arm 60 at the rear wall 20. The rear wall 20 can further define a second portion 28 that is between the inner arm 60 and the second outer arm 80. As such, the second portion 28 can join together the inner arm 60 and the second outer arm 80 at the rear wall 20.

As further shown in FIG. 3, the one or more first outer arms 40 can terminate with a first outer end portion 42. In some embodiments, where multiple first outer arms 40 are provided extending from the rear wall 20, each of the multiple first outer arms 40 can optionally be joined together by the first outer end portion 42. In some embodiments, where multiple first outer arms 40 are provided extending from the rear wall 20, each of the first outer arms 40 can provide its first outer end portion 42 without necessarily joining to any other of the first outer arms 40 and/or first outer end portions 42 thereof.

The one or more inner arms 60 can terminate with an inner end portion 62. In some embodiments, where multiple inner arms 60 are provided extending from the rear wall 20, each of the multiple inner arms 60 can optionally be joined together by the inner end portion 62. In some embodiments, where multiple inner arms 60 are provided extending from the rear wall 20, each of the inner arms 60 can provide its inner end portion 62 without necessarily joining to any other of the inner arms 60 and/or inner end portion 62 thereof.

The one or more second outer arms 80 can terminate with a second outer end portion 82. In some embodiments, where multiple second outer arms 80 are provided extending from the rear wall 20, each of the multiple second outer arms 80 can optionally be joined together by the second outer end portion 82. In some embodiments, where multiple second outer arms 80 are provided extending from the rear wall 20, each of the second outer arms 80 can provide its own second outer end portion 82 without necessarily joining to any other of the second outer arms 80 and/or second outer end portion 82 thereof.

As further shown in FIG. 3, the clip 10 can include one or more first teeth 54 extending from the one or more first outer arms 40 and toward the rear wall 20. In some embodiments, the one or more first teeth 54 can each extend from the first outer end portion 42. Where multiple first teeth 54 are provided, the first teeth 54 can optionally extend in parallel with each other and/or within a same plane at different heights of the first outer end portion 42.

The clip 10 can further include one or more second teeth 74 extending from the one or more inner arms 60 and toward the rear wall 20. In some embodiments, the one or more second teeth 74 can each extend from the inner end portion 62. Where multiple second teeth 74 are provided, the second teeth 74 can optionally extend in parallel with each other and/or within a same plane at different heights of the inner end portion 62.

As further shown in FIG. 3, the clip 10 can include a latch 84 extending from the one or more second outer arms 80 and toward the rear wall 20. In some embodiments, the latch 84 can extend from the second outer end portion 82. The latch 84 can include and/or terminate in a tab 88 that extends away from the inner arm 60. The tab 88 can provide a mechanism for manually releasing the latch 84 by pulling it outwardly.

As shown in FIG. 4, the first outer arms 40 (concealed from view in FIG. 4), the inner arms 60, and the second outer arms 80 can be distributed to extend from different portions of the rear wall 20. For example, any two of the first outer arms 40, the inner arms 60, and the second outer arms 80 can extend from a different height of the rear wall 20. The clip 10 can optionally have vertical symmetry, for example, across the line A-A. It will be understood that different arrangements can be provided.

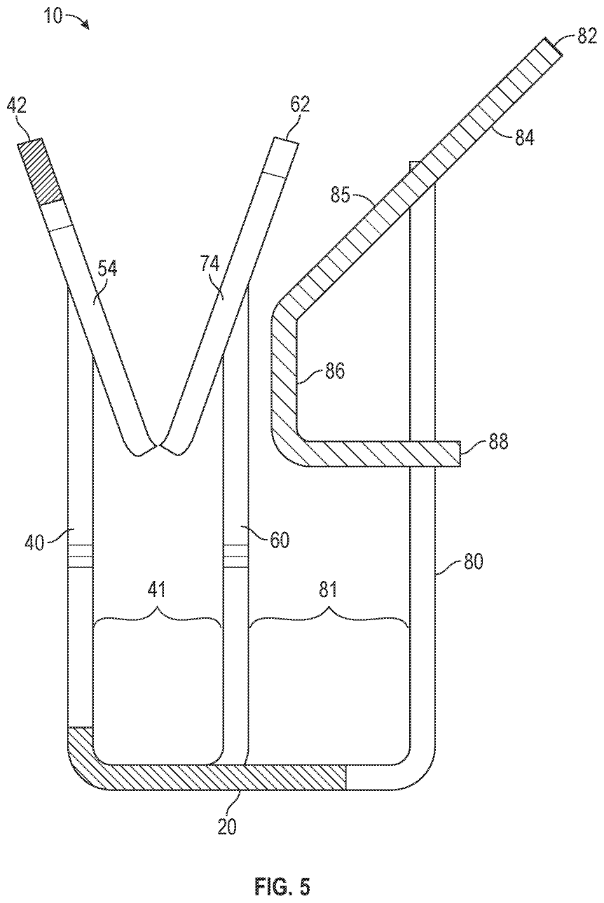

As shown in FIG. 5, the first teeth 54 and the second teeth 74 can be biased toward each other. For example, the first teeth 54 can extend somewhat towards the inner arm 60, and the second teeth 74 can extend somewhat towards the first outer arm 40. In some embodiments, the first teeth 54 and the second teeth 74 need not be biased against each other but can optionally provide a gap there between in a relaxed configuration. In some embodiments, the first teeth 54 and the second teeth 74 can be biased against each other in a relaxed configuration.

The one or more first outer end portions 42 and the one or more inner end portions 62 can each form a shape that is configured to receive a component between the one or more first outer arms 40 and the one or more inner arms 60. For example, the one or more first outer end portions 42 and the one or more inner end portions 62 can flare away from each other to form a widened opening that has a width that is greater than a gap between the one or more first outer arms 40 and the one or more inner arms 60.

The one or more second outer end portions 82 can each form a shape that is configured to receive another component between the one or more inner arms 60 and the one or more second outer arms 80. For example, the one or more second outer end portions 82 can flare away from the one or more inner end portions 62 to form a widened opening that has a width that is greater than a gap between the one or more inner arms 60 and the one or more second outer arms 80.

In some embodiments, a first gap 41 between the second outer arm 80 and the inner arm 60 can be larger (e.g., in width) than a second gap 81 between the first outer arm 40 and the inner arm 60. This can help accommodate a different in thickness of the corresponding components received therein. In some embodiments, the first gap 41 and the second gap 81 can have the same width.

The latch 84 can extend somewhat towards the inner arm 60. The latch 84 can include and/or define a ramp portion 85 for receiving a component, a middle portion 86 for extending within an opening of a component, and a tab 88 for resisting removal of the latch 84 from the opening until actuated (e.g., pulled away from the inner arm 60).

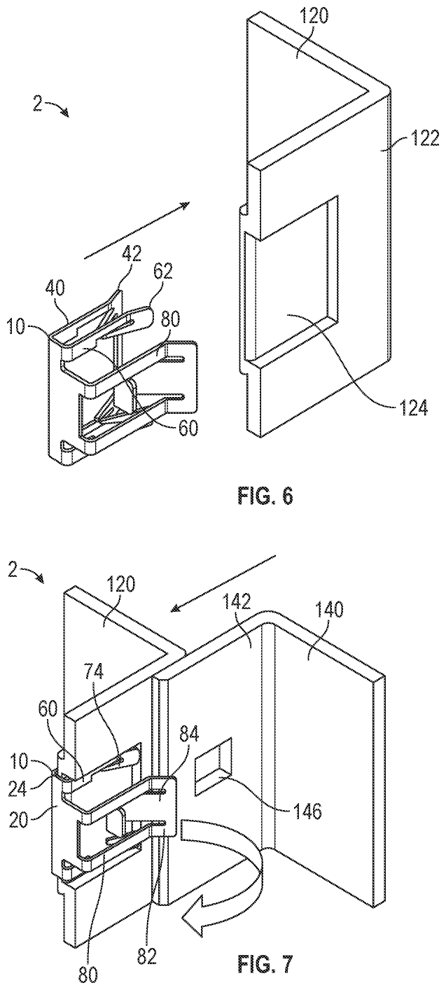

Referring now to FIGS. 6-9, a clip can couple any two components of a vehicle together to provide secure coupling of the components relative to each other. As shown in FIGS. 6-9, the assembly 2 can include a first component 120 and a second component 140. A clip 10 can be directly coupled to each of the first component 120 and the second component 140, such that the first component 120 and the second component 140 are coupled to each other.

In the example shown in FIGS. 6-9, the first component 120 can be, include, or be part of a fascia of a vehicle (e.g., the side front fascia 170 of FIG. 2), and the second component 140 be, include, or be part of a body of a vehicle (e.g., the body 180 of FIG. 2). It will be understood that the first component 120 and/or the second component 140 can represent any one or more components of the vehicle. As such, the assembly 2 can include a clip 10 that is directly coupled to any two components to maintain the relative positions thereof.

As shown in FIG. 6, the first component 120 can provide a first main wall 122 and a first engagement wall 124 for engagement with the clip 10. The first main wall 122 and the first engagement wall 124 can be formed by, coupled to, included with, and/or defined by the first component 120. For example, one or more portions of the first component 120 can have a position that corresponds to a position of the first main wall 122, and one or more other portions of the first component 120 can have a position that corresponds to a position of the first engagement wall 124. The first engagement wall 124 can be misaligned or otherwise protrude from the first main wall 122. The first main wall 122 can abut or otherwise engage another component. The first engagement wall 124 can engage the clip 10. The first engagement wall 124 can have a thickness that is different than a thickness of the first main wall 122.

The first engagement wall 124 of the first component 120 can be received between the first outer arm 40 and the inner arm 60 of the clip 10. The shape (e.g., flare) of the one or more first outer end portions 42 and the one or more inner end portions 62 can facilitate receipt of the first engagement wall 124 of the first component 120.

As shown in FIG. 7, the first component 120 is received between the one or more first outer end portions 42 and the one or more inner end portions 62, and the first component 120 is advanced between the one or more first outer arms 40 and the one or more inner arms 60. This can continue until the first component 120 eventually abuts the first portion 24 of the rear wall 20.

As further shown in FIG. 7, the second component 140 can provide a second main wall 142 for engagement with the clip 10. The second main wall 142 can be formed by, coupled to, included with, and/or defined by the second component 140. For example, one or more portions of the second component 140 can have a position that corresponds to a position of the second main wall 142. The second main wall 142 can abut or otherwise engage another component, such as the first main wall 122 of the first component 120. The second component 140 can further include an opening 146 extending through the second main wall 142 for receiving a portion of the clip 10.

The second main wall 142 of the second component 140 can be received between the inner arm 60 and the second outer arm 80 of the clip 10. The shape (e.g., flare) of the one or more second outer end portions 82 can facilitate receipt of the second main wall 142 of the second component 140. The recess formed by the first engagement wall 124 of the first component 120 can maintain the one or more inner end portions 62 of the one or more inner arms 60 to not extend to the second main wall 142 of the second component 140.

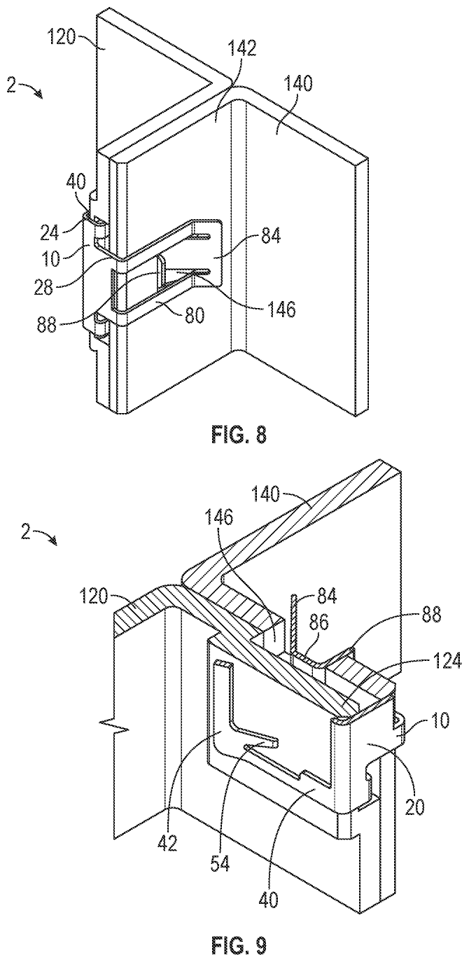

As shown in FIG. 8, the second component 140 is received and advanced between the one or more inner arms 60 and the one or more second outer arms 80. This can continue until the second component 140 eventually abuts the second portion 28 of the rear wall 20.

As shown in FIG. 9, the first teeth 54 and the second teeth 74 (see FIG. 7) can engage the first engagement wall 124 of the first component 120 on opposing sides thereof. The first teeth 54 and the second teeth 74 can include features to provide secure engagement. For example, where the first engagement wall 124 of the first component 120 comprises a malleable material (e.g., plastic), the first teeth 54 and the second teeth 74 can protrude into surfaces of the first engagement wall 124. Where the first teeth 54 and the second teeth 74 have angles of extension towards the rear wall 20 and are biased against the first engagement wall 124, the first teeth 54 and the second teeth 74 can resist reverse movement (e.g., removal) of the first component 120 until manually disengaged or until a sufficient force is applied.

As further shown in FIG. 9, the latch 84 can engage the opening 146 of the second component 140. The latch 84 can extend somewhat towards the inner arm 60 and into the opening 146. The middle portion 86 of the latch 84 can extend into the opening 146 of the second component 140, and the tab 88 can resist reverse movement (e.g., removal) of the second component 140 until manually disengaged by pulling the tab 88 and removing the middle portion 86 from the opening 146. While secured, the latch 84 can, with the tab 88, urge the second component 140 against the second portion 28 of the rear wall 20 of the clip 10. Accordingly, the second component 140 can be maintained in a particular position relative to the clip 10 in at least one axis.

It will be understood that the first component 120 and the second component 140 need not have the same features. For example, the first component 120 can have a first material (e.g., plastic), first dimension(s), and/or other features. By further example, the second component 140 can have a second material that is the same or different than the first material, second dimension(s) that are the same or different than the first dimension(s), and/or other features that are the same or different from those of the first component 120. The clip 10 can provide the features described herein to accommodate such possible differences.

While only one clip 10 is shown in FIGS. 6-9, it will be understood that multiple clips 10 can be provided for coupling the same first component 120 and second component 140. For example, any number of clips 10 can be provided to couple a first component 120 to a second component 140. Each of the multiple clips 10 can be distributed along a length of each of the first component 120 and the second component 140. Accordingly, an interface region between the first component 120 and the second component 140 can be maintained as consistent along its length.

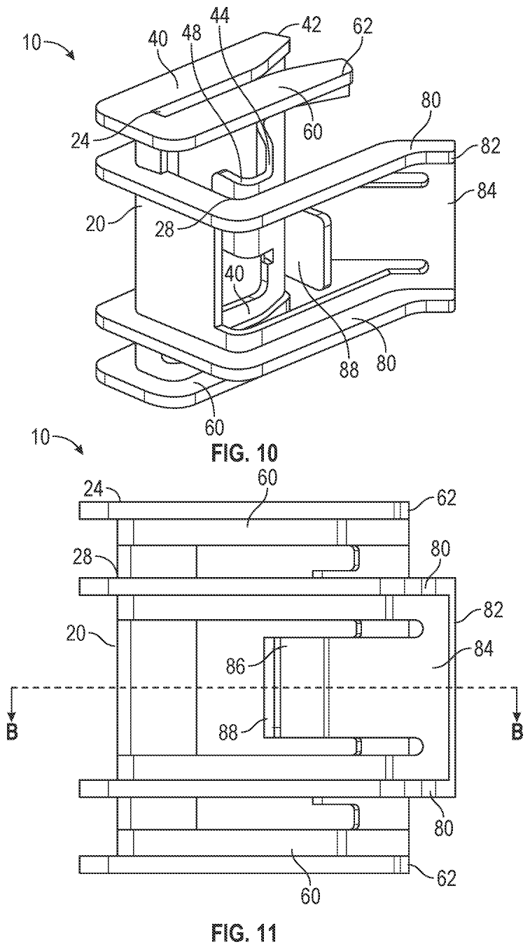

Referring now to FIGS. 10-12, a clip can be provided to secure two components to each other. Such a clip can provide various features for receiving and engaging the components in a secured configuration.

As shown in FIG. 10, a clip 10 can include a rear wall 20 on a side thereof. The rear wall 20 can define an end portion of the clip 10 against wish components received therein can abut. The clip 10 can further include multiple arms extending from the rear wall 20. For example, the clip 10 can include a first outer arm 40, a second outer arm 80, and an inner arm 60. Each of the first outer arm 40, the inner arm 60, and the second outer arm 80 can extend from the rear wall 20. At least a portion of each of the first outer arm 40, the inner arm 60, and the second outer arm 80 can extend in a same direction on a same side of the rear wall 20. For example, at least a portion of each of the first outer arm 40, the inner arm 60, and the second outer arm 80 can extend in parallel with each other. The inner arm 60 can extend from an inner portion of the rear wall 20 that is between outer portions of the rear wall 20, from which the first outer arm 40 and the second outer arm 80 extend. As such, the inner arm 60 can be between the first outer arm 40 and the second outer arm 80, with respect to a width across the rear wall 20.

The rear wall 20 can define a first portion 24 that is between the first outer arm 40 and the inner arm 60. As such, the first portion 24 can join together the first outer arm 40 and the inner arm 60 at the rear wall 20. The rear wall 20 can further define a second portion 28 that is between the inner arm 60 and the second outer arm 80. As such, the second portion 28 can join together the inner arm 60 and the second outer arm 80 at the rear wall 20.

As further shown in FIG. 10, the one or more first outer arms 40 can terminate with a first outer end portion 42. In some embodiments, where multiple first outer arms 40 are provided extending from the rear wall 20, each of the multiple first outer arms 40 can optionally be joined together by the first outer end portion 42. In some embodiments, where multiple first outer arms 40 are provided extending from the rear wall 20, each of the first outer arms 40 can provide its first outer end portion 42 without necessarily joining to any other of the first outer arms 40 and/or first outer end portions 42 thereof.

The clip 10 can include a first latch 44 extending from the one or more first outer arms 40 and toward the rear wall 20. In some embodiments, the first latch 44 can extend from the first outer end portion 42. The first latch 44 can include and/or terminate in a first tab 48 that extends away from the inner arm 60. The first tab 48 can provide a mechanism for manually releasing the first latch 44 by pulling it outwardly.

The one or more inner arms 60 can terminate with an inner end portion 62. In some embodiments, where multiple inner arms 60 are provided extending from the rear wall 20, each of the multiple inner arms 60 can optionally be joined together by the inner end portion 62. In some embodiments, where multiple inner arms 60 are provided extending from the rear wall 20, each of the inner arms 60 can provide its inner end portion 62 without necessarily joining to any other of the inner arms 60 and/or inner end portion 62 thereof.

The one or more second outer arms 80 can terminate with a second outer end portion 82. In some embodiments, where multiple second outer arms 80 are provided extending from the rear wall 20, each of the multiple second outer arms 80 can optionally be joined together by the second outer end portion 82. In some embodiments, where multiple second outer arms 80 are provided extending from the rear wall 20, each of the second outer arms 80 can provide its own second outer end portion 82 without necessarily joining to any other of the second outer arms 80 and/or second outer end portion 82 thereof.

The clip 10 can include a second latch 84 extending from the one or more second outer arms 80 and toward the rear wall 20. In some embodiments, the second latch 84 can extend from the second outer end portion 82. The second latch 84 can include and/or terminate in a second tab 88 that extends away from the inner arm 60. The second tab 88 can provide a mechanism for manually releasing the second latch 84 by pulling it outwardly.

As shown in FIG. 11, the first outer arms 40 (concealed from view in FIG. 11), the inner arms 60, and the second outer arms 80 can be distributed to extend from different portions of the rear wall 20. For example, any two of the first outer arms 40, the inner arms 60, and the second outer arms 80 can extend from a different height of the rear wall 20. The clip 10 can optionally have vertical symmetry, for example, across the line A-A. It will be understood that different arrangements can be provided.

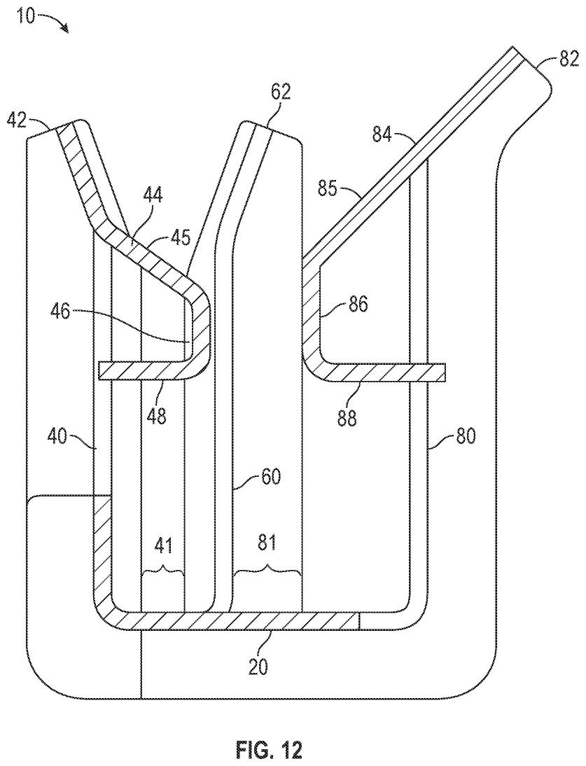

As shown in FIG. 12, the first latch 44 and the second latch 84 can be biased toward each other. For example, the first latch 44 and the second latch 84 can each extend somewhat towards the inner arm 60.

The one or more first outer end portions 42 and the one or more inner end portions 62 can each form a shape that is configured to receive a component between the one or more first outer arms 40 and the one or more inner arms 60. For example, the one or more first outer end portions 42 and the one or more inner end portions 62 can flare away from each other to form a widened opening that has a width that is greater than a gap between the one or more first outer arms 40 and the one or more inner arms 60.

The one or more second outer end portions 82 can each form a shape that is configured to receive another component between the one or more inner arms 60 and the one or more second outer arms 80. For example, the one or more second outer end portions 82 can flare away from the one or more inner end portions 62 to form a widened opening that has a width that is greater than a gap between the one or more inner arms 60 and the one or more second outer arms 80.

In some embodiments, a first gap 41 between the second outer arm 80 and the inner arm 60 can be larger (e.g., in width) than a second gap 81 between the first outer arm 40 and the inner arm 60. This can help accommodate a different in thickness of the corresponding components received therein. In some embodiments, the first gap 41 and the second gap 81 can have the same width.

The first latch 44 can extend somewhat towards the inner arm 60. The first latch 44 can include and/or define a first ramp portion 45 for receiving a component, a first middle portion 46 for extending within an opening of a component, and a first tab 48 for resisting removal of the first latch 44 from the opening until actuated (e.g., pulled away from the inner arm 60).

The second latch 84 can extend somewhat towards the inner arm 60. The second latch 84 can include and/or define a second ramp portion 85 for receiving a component, a second middle portion 86 for extending within an opening of a component, and a second tab 88 for resisting removal of the second latch 84 from the opening until actuated (e.g., pulled away from the inner arm 60).

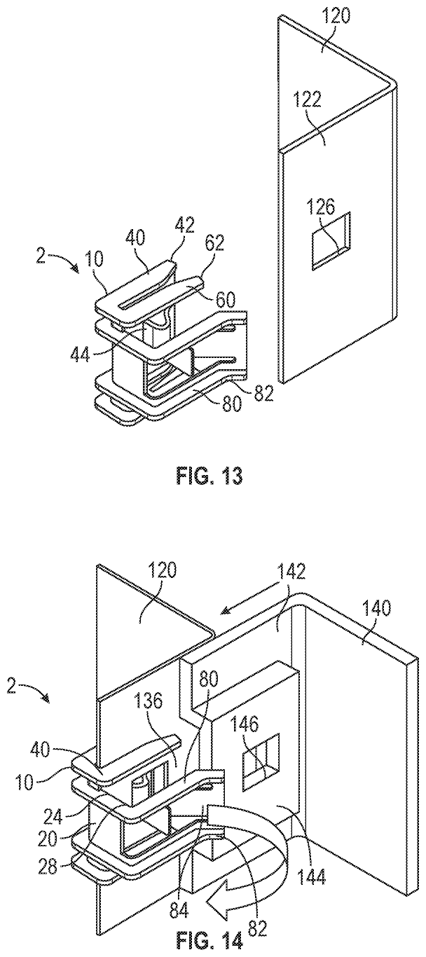

Referring now to FIGS. 13-16, a clip can couple any two components of a vehicle together to provide secure coupling of the components relative to each other. As shown in FIGS. 13-16, the assembly 2 can include a first component 120 and a second component 140. A clip 10 can be directly coupled to each of the first component 120 and the second component 140, such that the first component 120 and the second component 140 are coupled to each other.

In the example shown in FIGS. 13-16, the first component 120 can be, include, or be part of a fascia of a vehicle (e.g., the side front fascia 170 of FIG. 2), and the second component 140 be, include, or be part of a body of a vehicle (e.g., the body 180 of FIG. 2). It will be understood that the first component 120 and/or the second component 140 can represent any one or more components of the vehicle. As such, the assembly 2 can include a clip 10 that is directly coupled to any two components to maintain the relative positions thereof.

As shown in FIG. 13, the first component 120 can provide a first main wall 122 for engagement with the clip 10. The first main wall 122 can be formed by, coupled to, included with, and/or defined by the first component 120. For example, one or more portions of the first component 120 can have a position that corresponds to a position of the first main wall 122. The first main wall 122 can abut or otherwise engage another component. The first component 120 can further include a first opening 126 extending through the first main wall 122 for receiving a portion of the clip 10.

The first engagement wall 124 of the first component 120 can be received between the first outer arm 40 and the inner arm 60 of the clip 10. The shape (e.g., flare) of the one or more first outer end portions 42 and the one or more inner end portions 62 can facilitate receipt of the first engagement wall 124 of the first component 120.

As shown in FIG. 14, the first component 120 is received between the one or more first outer end portions 42 and the one or more inner end portions 62, and the first component 120 is advanced between the one or more first outer arms 40 and the one or more inner arms 60. This can continue until the component 120 eventually abuts the first portion 24 of the rear wall 20.

As further shown in FIG. 14, the second component 140 can provide a second main wall 142 and a second engagement wall 144 for engagement with the clip 10. The second main wall 142 and the second engagement wall 144 can be formed by, coupled to, included with, and/or defined by the second component 140. For example, one or more portions of the second component 140 can have a position that corresponds to a position of the second main wall 142, and one or more other portions of the second component 140 can have a position that corresponds to a position of the second engagement wall 144. The second engagement wall 144 can be misaligned or otherwise protrude from the second main wall 142. The second main wall 142 can abut or otherwise engage another component, such as the first main wall 122 of the first component 120. The second engagement wall 144 can engage the clip 10. The second engagement wall 144 can have a thickness that is different than a thickness of the second main wall 142.

The second main wall 142 of the second component 140 can be received between the inner arm 60 and the second outer arm 80 of the clip 10. The shape (e.g., flare) of the one or more second outer end portions 82 can facilitate receipt of the second main wall 142 of the second component 140. The recess formed by the second engagement wall 144 of the second component 140 can receive the one or more inner end portions 62 of the one or more inner arms 60 to allow the second component 140 to pass over the inner arm 60.

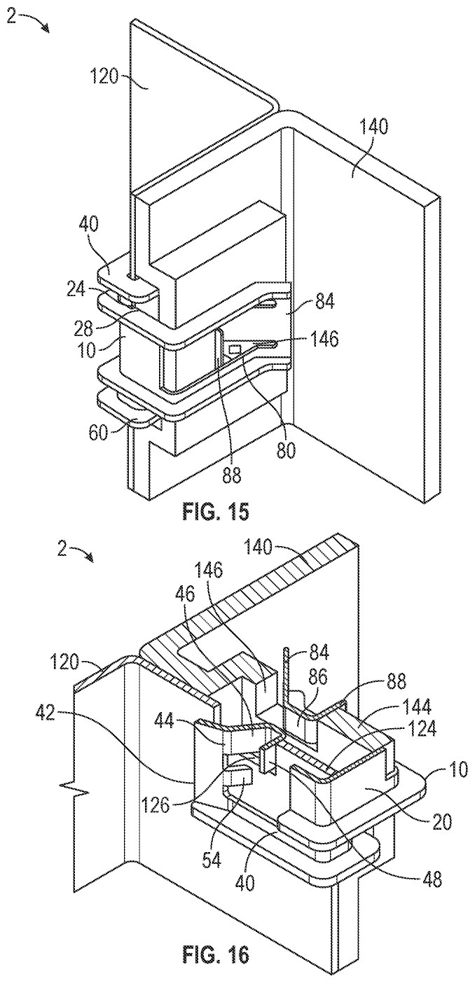

As shown in FIG. 15, the second component 140 is received and advanced between the one or more inner arms 60 and the one or more second outer arms 80. This can continue until the second component 140 eventually abuts the second portion 28 of the rear wall 20.

As shown in FIG. 16, the first latch 44 can engage the first opening 126 of the first component 120. The first latch 44 can extend somewhat towards the inner arm 60 and into the first opening 126. The first middle portion 46 of the first latch 44 can extend into the first opening 126 of the first component 120, and the first tab 48 can resist reverse movement (e.g., removal) of the first component 120 until manually disengaged by pulling the first tab 48 and removing the first middle portion 46 from the first opening 126. While secured, the first latch 44 can, with the first tab 48, urge the first component 120 against the first portion 24 of the rear wall 20 of the clip 10. Accordingly, the first component 120 can be maintained in a particular position relative to the clip 10 in at least one axis.

As further shown in FIG. 16, the second latch 84 can engage the second opening 146 of the second component 140. The second latch 84 can extend somewhat towards the inner arm 60 and into the second opening 146. The second middle portion 86 of the second latch 84 can extend into the second opening 146 of the second component 140, and the second tab 88 can resist reverse movement (e.g., removal) of the second component 140 until manually disengaged by pulling the second tab 88 and removing the second middle portion 86 from the second opening 146. While secured, the second latch 84 can, with the second tab 88, urge the second component 140 against the second portion 28 of the rear wall 20 of the clip 10. Accordingly, the second component 140 can be maintained in a particular position relative to the clip 10 in at least one axis.

In some embodiments, as further shown in FIG. 16, the clip 10 can include one or more teeth 54 extending from the one or more first outer arms 40 and toward the rear wall 20. For example, the one or more teeth 54 can extend alongside the first latch 44. In some embodiments, the one or more teeth 54 can each extend from the first outer end portion 42. The teeth 54 can be biased toward the inner arm 60 and/or the second outer arm 80. In the assembly 2, the teeth 54 can be biased against the first component 120 when the first component is coupled to the clip 10. The biasing provided by the teeth 54 can urge the first component against the inner arm 60 and/or the second component 140. This can remove differences in thickness to allow the first component 120 and the second component 140 to achieve a preferred arrangement in assembly 2. For example, even if the first component 120 is thinner than the gap between the first outer arm 40 and the inner arm 60, the first component 120 can be biased against the inner arm 60 and/or the second component 140.

In some embodiments, at least one of the latches can have a height that is smaller than the opening into which it is inserted. The corresponding component can be moved along such a height by an extent defined by the different in the height of the latch and the height of the opening. Accordingly, the relative positions of the components can be adjusted in at least one axis.

It will be understood that the first component 120 and the second component 140 need not have the same features. For example, the first component 120 can have a first material (e.g., metal), first dimension(s), and/or other features. By further example, the second component 140 can have a second material (e.g., plastic) different than the first material, second dimension(s) different than the first dimension(s), and/or other features that differ from those of the first component 120. The clip 10 can provide the features described herein to accommodate such differences. For example, the latches can secure regardless of the malleability of the materials of the components.

While only one clip 10 is shown in FIGS. 13-16, it will be understood that multiple clips 10 can be provided for coupling the same first component 120 and second component 140. For example, any number of clips 10 can be provided to couple a first component 120 to a second component 140. Each of the multiple clips 10 can be distributed along a length of each of the first component 120 and the second component 140. Accordingly, an interface region between the first component 120 and the second component 140 can be maintained as consistent along its length.

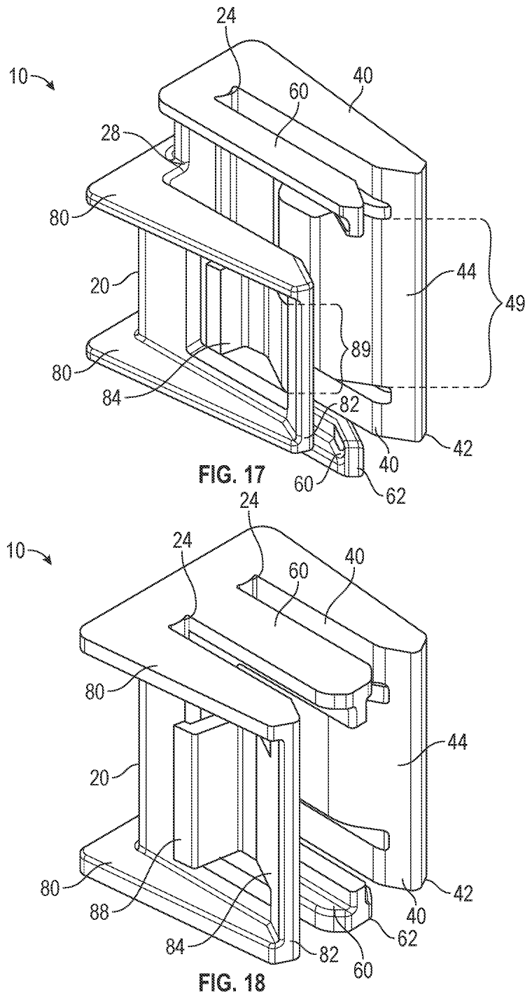

Referring now to FIGS. 17, a clip can be provided to secure two components to each other. Such a clip can provide various features for receiving and engaging components that have different features from each other. It will be understood that the clip 10 of FIG. 17 can include one or more of the features of any other clip described herein, including the clips of FIGS. 3-16, unless otherwise indicated herein.

As shown in FIG. 17, a clip 10 can have one or more dissimilar features on opposing sides thereof. In some embodiments, the clip 10 can include a first outer arm 40 and an inner arm 60 that defines a first gap there between. The clip can further include a second outer arm 80 that defines a second gap between the second outer arm 80 and the inner arm 60. The width of the first gap between the first outer arm 40 and the inner arm 60 can be different (e.g., larger or smaller) than the width of the second gap between the second outer arm 80 and the inner arm 60. This can help accommodate different components of different thicknesses. Accordingly, the restrictive width of the narrower gap can refuse insertion of the thicker of the two components, thereby providing an indication to the user of a preferred arrangement of the assembly.

In some embodiments, the clip 10 can include a first latch 44 extending from the first outer arm 40 and a second latch 84 extending from the second outer arm 80. The first height 49 of the first latch 44 can be different (e.g., larger or smaller) than the second height 89 of the second latch 84. Where the components each provide an opening have a corresponding height and where such heights of the openings are different, the taller of the two latches may be inserted into only one of the openings. Accordingly, the restrictive height of the taller latch can refuse insertion into the smaller of the two openings, thereby providing an indication to the user of a preferred arrangement of the assembly.

Referring now to FIGS. 18, a clip can be provided to secure two components to each other. Such a clip can provide various features with symmetry for receiving and engaging components that have similar features as each other. It will be understood that the clip 10 of FIG. 18 can include one or more of the features of any other clip described herein, including the clips of FIGS. 3-17, unless otherwise indicated herein.

As shown in FIG. 17, a clip 10 can include a first outer arm 40, a second outer arm 80, and an inner arm 60 each extending from a rear wall 20. In some embodiments, the clip 10 can be symmetric on opposing sides of the inner arm 60. For example, the first outer arm 40 and the second outer arm 80 can provide the same features on opposing sides of the inner arm 60. By further example, the first outer arm 40 and the second outer arm 80 can have the same height as each other and distance from the inner arm 60. In some embodiments, where the clip 10 further includes a first latch 44 and a second latch 84 on opposing sides of the inner arm 60, the first latch 44 and the second latch 84 can provide symmetry across the inner arm 60. For example, the first latch 44 and the second latch 84 can have the same height as each other and distance from the inner arm 60. The clip 10 can facilitate assembly with components having the same or similar features. It will be understood that the components can be inserted into either of the gaps formed by the first outer arm 40, the inner arm 60, and the second outer arm 80. As such, the clip 10 can provide assembly in at least two different arrangements (e.g., orientation) thereof.

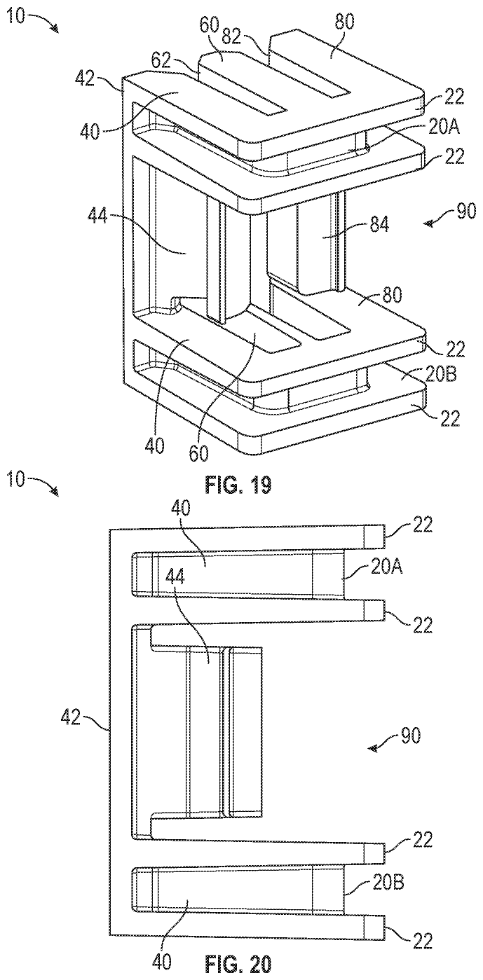

Referring now to FIGS. 19 and 20, a clip can be provided to secure two components to each other. Such a clip can provide various features including an open rear side that provides access to the components. It will be understood that the clip 10 of FIGS. 19 and 20 can include one or more of the features of any other clip described herein, including the clips of FIGS. 3-18, unless otherwise indicated herein.

As shown in FIGS. 19 and 20, a clip 10 can include a first outer arm 40, a second outer arm 80, and an inner arm 60 each extending from rear walls 20A and 20B. The rear walls 20A and 20B can be formed by discrete portions on upper and lower ends of the clip 10. For example, a first one of each of first outer arm 40, the inner arm 60, and the second outer arm 80 can extend from a first rear wall 20A, and a second one of each of first outer arm 40, the inner arm 60, and the second outer arm 80 can extend from a second rear wall 20B. The rear walls 20A and 20B can be joined together by at least a first outer end portion 42, inner end portions 62, and/or a second outer end portion 82. Thus, a gap 90 can be defined between the rear walls 20A and 20B such that they are separated by a given height. A first latch 44 and/or a second latch 84 can extend within and/or toward the gap 90 between the rear walls 20A and 20B. In some embodiments, the clip 10 can optionally provide symmetry across the width of the clip (e.g., across the inner arm 60). In some embodiments, the clip 10 can optionally provide symmetry across the height of the clip 10.

The clip 10 can include one or more ribs 22 for providing support and enhance rigidity to the clip 10. For example one or more ribs 22 having increased thickness can be provided at each of the rear walls 20A and 20B and/or extending along one or more of the first outer arm 40, the second outer arm 80, and/or the inner arm 60.

One or more of the clips described herein can be formed from one of a variety of materials, including metal, plastic, and the like. In some embodiments, a clip can be formed as a monolithic structure, such as one that is integrally formed of a single piece of material, rather than of separate pieces that are joined together by an interface. For example, a rear wall, arms, teeth, and/or latches can be a unibody and/or unitary structure. By providing a monolithic, unitary, and/or unibody structure, the clip 10 does not contain interfaces or discontinuities, such as those that occur in assembled parts. Accordingly, the monolithic, unitary, and/or unibody clip 10 can be fabricated to more precise and consistent dimensions as well as provide greater structural support. In some embodiments, the clip 10 can be formed by injection molding or another process that forms the monolithic structure thereof.

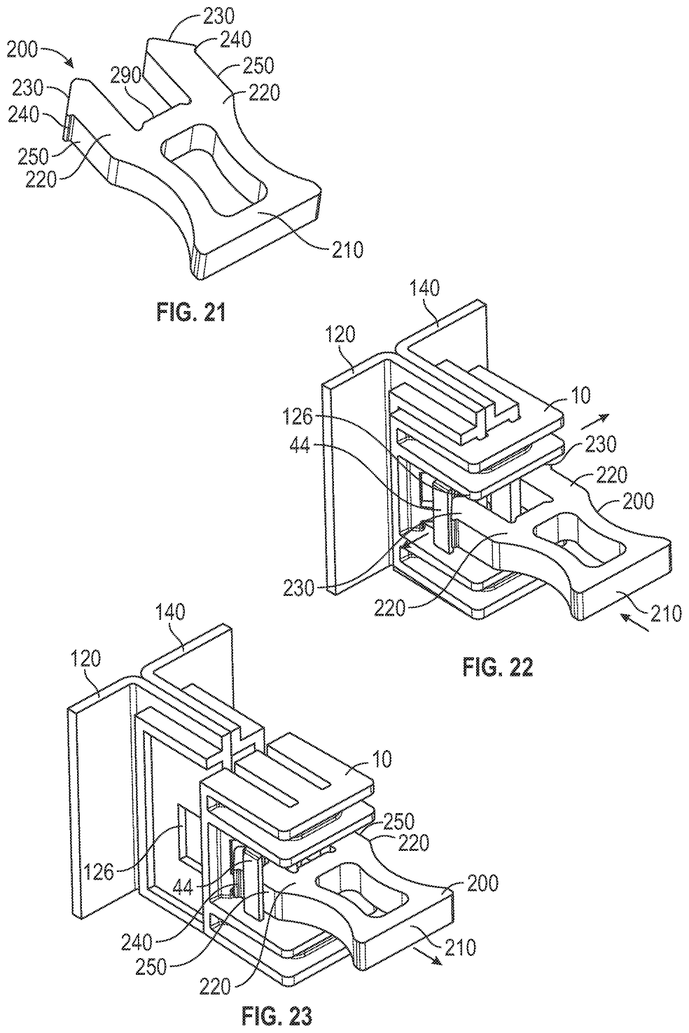

Referring now to FIGS. 21-23, a removal tool can be provided to remove a clip from an assembly. It will be understood that the removal tool described herein can be used with any one or more of the clips described herein.

A removal tool can include various features to facilitate engagement with and removal of a clip. As shown in FIG. 21, a removal tool 200 can include a handle 210 for grasping and operation by a user. The removal tool 200 can further include one or more tines 220 that extend from the handle 210. For example, the removal tool 200 can include a pair of tines 220. The tines 220 can be separated from each other by a gap 290. Each of the tines 220 can include a ramp 230 at a terminal end thereof. The ramps 230 can slope away from each other in a manner that facilitates engagement with a clip and sliding of the removal tool 200 with respect to the clip. For example, each of the ramps 230 can provide an increasing with as the ramps 230 extend away from the terminal end of the removal tool 200 and/or toward the handle 210. Each of the tines 220 can further include an engagement section 250. A width across the removal tool 200 at a region including the engagement sections 250 can be less than a maximum width across the removal tool 200 at a portion of the ramps 230. For example, the tines 220 can transition from a maximum width of the ramps 230 to a smaller width of the engagement sections to define shoulders 240. The shoulders 240 can provide a step for transitioning from the ramps 230 to the engagement sections 250. A surface of the shoulders 240 can face away from the ramps 230 and/or toward the handle 210.

The removal tool 200 can be used to release a clip 10 while the clip 10 is securing together a first component 120 and a second component 140. As shown in FIG. 22, the removal tool 200 can be brought to a clip 10. The ramps 230 of the removal tool 200 can engage a first latch 44 and/or a second latch (not shown in FIG. 22) of the clip 10. As the removal tool 200 is advanced, the first latch 44 and the second latch can be urged away from each other and/or out of corresponding openings of the first component 120 and the second component 140. For example, the increasing width of the removal tool 200 at the ramps 230 can help urge the first latch 44 and the second latch outwardly. Such an action (e.g., advancing the removal too 200) can continue until the ramps 230 pass beyond a portion of the first latch 44 and/or the second latch.

The removal tool 200 can further be used to engage and remove the clip 10 from the first component 120 and the second component 140. As shown in FIG. 23, the removal tool 200 can be positioned with the ramps 230 extending beyond the first latch 44 and the second latch (not shown in FIG. 22) of the clip 10. For example, the shoulders 240 of the removal tool 200 can be positioned on a side of the first latch 44 and the second latch that is opposite the handle 210. With the shoulders 240 positioned on a far side of the first latch 44 and the second latch, the first latch 44 and the second latch can be maintained a distance away from each other and/or the first component 120 and the second component 140. For example, while the first latch 44 and the second latch are resting along the engagement sections 250 of the tines 220, the first latch 44 and the second latch can be maintained in positions that are outside of the first opening 126 of the first component 120 and the second opening (not shown) of the second component 140. As the user pulls the removal tool 200 away from the first component 120 and the second component 140 (e.g., by pulling the handle 210), the shoulders 240 of the removal tool 200 can engage the first latch 44 and the second latch to pull the clip 10 along with the removal tool 200. During such action, because the first latch 44 and the second latch are expanded by the engagement sections 250 of the tines 220, the clip 10 can be removed from the first component 120 and the second component 140. As such, the assembly can be disassembled with the removal tool 200. The removal tool 200 can optionally be removed from the clip 10 by independently separating the first latch 44 and/or the second latch to allow the shoulders 240 to pass thereby. It will be understood that the clip 10 can subsequently be reintroduced to the first component 120 and/or the second component 140 to reform the assembly.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A clip comprising:
a rear wall;
a first outer arm extending from the rear wall;
a second outer arm extending from the rear wall;
an inner arm extending from a portion of the rear wall that is between the first outer arm and the second outer arm;
a first tooth extending from the first outer arm toward the rear wall;
a second tooth extending from the inner arm toward the rear wall, the first tooth and the second tooth being biased toward each other; and
a latch extending from the second outer arm toward the rear wall, the latch being biased toward the inner arm.

2. The clip of claim 1, wherein a gap between the second outer arm and the inner arm is larger than a gap between the first outer arm and the inner arm.

3. The clip of claim 1, wherein an end portion of the first outer arm and an end portion of the inner arm flare away from each other.

4. The clip of claim 1, wherein a tab of the latch extends away from the inner arm.

5. The clip of claim 1, wherein the first tooth and the second tooth are biased towards each other.

6. The clip of claim 1, further comprising:
a third tooth extending from the first outer arm and in parallel with the first tooth; and
a fourth tooth extending from the inner arm and in parallel with the second tooth.

7. A clip comprising:
a rear wall;
a first outer arm extending from the rear wall;
a second outer arm extending from the rear wall;
an inner arm extending from a portion of the rear wall that is between the first outer arm and the second outer arm;
a first latch extending from the first outer arm toward the rear wall, the first latch being biased toward the inner arm; and
a second latch extending from the second outer arm toward the rear wall, the second latch being biased toward the inner arm.

8. The clip of claim 7, wherein the clip is symmetric on opposing sides of the inner arm.

9. The clip of claim 7, wherein the first latch has a first height that is different than a second height of the second latch.

10. The clip of claim 7, further comprising a tooth extending from the first outer arm toward the rear wall and being biased toward the inner arm.

11. The clip of claim 7, wherein a gap between the second outer arm and the inner arm is larger than a gap between the first outer arm and the inner arm.

12. The clip of claim 7, wherein an end portion of the first outer arm and an end portion of the inner arm flare away from each other.

13. The clip of claim 7, wherein:
a first tab forming an end of the first latch extends away from the inner arm; and
a second tab forming an end of the second latch extends away from the inner arm.

14. A vehicle comprising:
a first component having a first opening;
a second component having a second opening and forming a recess; and
a clip comprising:
a first outer arm extending on an outer side of the first component;
a second outer arm extending on an outer side of the second component;
an inner arm extending between the first component and the second component and within the recess of the second component;
a first latch extending from the first outer arm and into the first opening of the first component; and
a second latch extending from the second outer arm and into the second opening of the second component.

15. The vehicle of claim 14, wherein the clip is symmetric on opposing sides of the inner arm, wherein a second thickness of the second component is equal to a first thickness of the first component.

16. The vehicle of claim 14, wherein the second latch has a height that is less than a height of the second opening of the second component, wherein the second component is slidable with respect to the clip while the second latch is within the second opening.

17. The vehicle of claim 14, further comprising a tooth extending from the first outer arm and being biased against the first component.

18. The vehicle of claim 14, wherein:
a second thickness of the second component is greater than a first thickness of the first component; and
a gap between the second outer arm and the inner arm is larger than a gap between the first outer arm and the inner arm.

19. The vehicle of claim 14, wherein an end portion of the first outer arm and an end portion of the inner arm flare away from each other.

20. The vehicle of claim 14, wherein:
a first tab forming an end of the first latch extends away from the inner arm; and
a second tab forming an end of the second latch extends away from the inner arm.
